(19) United States
(12) Patent Application Publication
(10) Pub. No.: US 2025/0182770 A1
(43) Pub. Date: Jun. 5, 2025

(54) USING TRUSTED TOKENS FOR VOICE AUTHENTICATION

(71) Applicant: Wells Fargo Bank, N.A., San Francisco, CA (US)

(72) Inventors: Jeff J. Stapleton, O'Fallon, MO (US); Peter Bordow, Fountain Hill, AZ (US); Michael Erik Meinholz, Charlotte, NC (US); Ilber Gashi, Huntersville, NC (US)

(21) Appl. No.: 17/665,188

(22) Filed: Feb. 4, 2022

(51) Int. Cl. G10L 19/018; H04L 9/32; H04R 5/04

(52) U.S. Cl. CPC G10L 19/018; H04L 9/3213; H04R 5/04; H04L 2209/04

(57) ABSTRACT

Systems, apparatuses, methods, and computer program products are disclosed for securing communications between an initiating device and a participating device. An example method includes obtaining audio to be provided to the participating device; embedding a token using steganography in the audio to obtain embedded audio; modifying the embedded audio based on a content concealment scheme to obtain an audio package that conceals content of the audio; and providing the audio package to the participating device.

### BACKGROUND

Modern systems may facilitate communication between parties at various physical locations. The systems may be highly distributed with various components being located substantial distances from one another. The distances between these components and flaws in the operation of the components may allow for third parties to gain access to communications between parties using these systems.

### BRIEF SUMMARY

Communication systems facilitate a broad array of interactions between computer systems and users thereof. As part of these interactions, the computer systems may send and receive sensitive data. Third parties may attempt to access the sensitive data through a range of different tactics.

To reduce the likelihood of third parties gaining access to the sensitive data, various security operations may be performed such as authentication of parties to communications, encrypting of data communicated between devices, etc. However, these security operations may presume that actors in a distributed system will operate in accordance with certain expectations. Consequently, if an actor in a distributed system is compromised, the communication security between components of the distributed system may be compromised.

Systems, apparatuses, methods, and computer program products are disclosed herein for communication security in a distributed system. The communication security may be provided through a combination of authentication, encryption, steganography, and/or other actions (e.g., “protective actions”). The protective actions may allow for communications between components of a distributed system to be made that may not be utilized by compromised components to obtain sensitive data. Further, the protective actions may facilitate identification of spoofed, faked, or otherwise unauthorized communications by compromised components (which may otherwise induce users of components of the distributed system to disclose sensitive data). Consequently, a system in accordance with embodiments disclosed herein may be less susceptible to attack by malicious parties.

In one example embodiment, a method for authenticating audio communications between an initiating device and a participating device is provided. The method may include obtaining, by audio generation circuitry of the initiating device, audio to be provided to the participating device; embedding, by communications security circuitry of the initiating device, a token using steganography in the audio to obtain an embedded audio; modifying, by audio embedding circuitry of the initiating device, the embedded audio based on a content concealment scheme to obtain an audio package that conceals content of the embedded audio; and providing, by communication hardware of the initiating device, the audio package to the participating device.

The audio may be modified by performing, using a selected content concealment scheme, a content concealment operation on the embedded audio so that the content of the embedded audio is unable to be reconstructed using the audio package without access to the content concealment scheme. The token embedded in the audio may be used to authenticate audio after the content concealment scheme has been addressed.

The content concealment operation may include encrypting the content to obtain encrypted content.

The token embedded in the audio may include a bit sequence usable to perform an authentication for the audio package. The bit sequence may also be usable to authenticate the initiating device to the participating device.

The token may be embedded in the audio of the audio package as an imperceptible audible portion of the modified audio.

The token may be embedded in control information for the audio package.

The audio may include a voice communication directed to a user of the participating device, the initiating device and the participating device being part of a distributed system in which communications are not intrinsically trusted. The initiating device and the participating device are operably connected to each other via a network environment and are subject to compromise by other entities in the network environment.

In another example embodiment, an initiating device is provided. The initiating device may include the audio generation circuitry, the audio embedding circuitry, the communications security circuitry, and the communication hardware, as well as other components.

In a further example embodiment, a method for securing audio communications between an initiating device and a participating device is provided. The method may include obtaining, by communications hardware of the participating device, an audio package from the initiating device, and a token may be embedded with steganography in audio of the audio package; performing, by token retrieval circuitry of the participating device, an attempt to extract, by token retrieval circuitry of the participating device, the token from the audio package; and in response to the attempt being successful: when the token indicates that the audio package is from the initiating device: reconstructing, by audio modification circuitry of the participating device, the audio from the audio package using the token, and treating, by security circuitry of the participating device, the audio as being from an authenticated device; and when the token does not indicate that the audio package is from the initiating device: performing, by the security circuitry, an action set to remediate risk associated with the audio package, and in response to the attempt being unsuccessful: performing, by the security circuitry, the action set.

The audio may be reconstructed by decryption or other action to reverse a content concealment operation performed on the audio by the initiating device, and content of the audio is unable to be reconstructed without access to the content concealment scheme that defines how the audio has been modified to conceal the content.

The token may identify the content concealment scheme according to which the content concealment operation was performed. The content concealment operation may include encrypting the content to obtain encrypted content. The token may include a bit sequence usable to: authenticate the encrypted content.

The bit sequence may also be usable to authenticate the initiating device to the participating device.

The token may be embedded in the audio of the audio package, and the token may be embedded as an imperceptible audible portion of the audio and/or in control information for the audio.

The audio may include a voice communication directed to a user of the participating device, the initiating device and the participating device being part of a distributed system in which communications are not intrinsically trusted.

The initiating device and the participating device are operably connected to each other via a network environment subject to compromise by other entities.

In an additional example embodiment, a participating device is provided. The participating device may include the audio management circuitry, the token retrieval circuitry, the audio modification security circuitry, the communication security circuitry, and the communication hardware, as well as other components.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used for authenticating devices and/or users thereof.

FIG. 2 illustrates a schematic block diagram of example circuitry embodying a device that may perform various operations in accordance with some example embodiments described herein.

FIG. 3 illustrates a schematic block diagram of example circuitry embodying a device that may perform various operations in accordance with some example embodiments described herein.

FIG. 4A illustrates a schematic block diagram of example data structures usable by a device that may perform various operations in accordance with some example embodiments described herein.

FIG. 4B illustrates a schematic block diagram of example data structures usable by a device that may perform various operations in accordance with some example embodiments described herein.

FIG. 5A illustrates an example flowchart for initiating communications between an initiating device and a participating device, in accordance with some example embodiments described herein.

FIG. 5B illustrates an example flowchart for participating in communication between an initiating device and a participating device, in accordance with some example embodiments described herein.

FIG. 6 illustrate example operations and data structures used by a system, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” is used herein to refer to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” is used to refer to any computing device capable of functioning as a server, such as a master exchange server, web server, mail server, document server, or any other type of server. A server may be a dedicated computing device or a server module (e.g., an application) hosted by a computing device that causes the computing device to operate as a server.

The term “audio” is used to refer to a representation of one or more sounds in a computing device such as an audio recording of a person talking. The representation may be stored in persistent storage and/or transitory storage (e.g., with an in-memory data structure).

### Overview

As noted above, example embodiments described herein provide methods, apparatuses, systems, and computer program products are described herein that provide for securing communications between components of a distributed system. The distributed system may facilitate voice communications between different persons using various components of the distributed system. As part of these voice communications, sensitive data may be distributed within the distributed system.

Traditionally, it has been difficult to secure communications between devices in distributed systems. Man in the middle and other types of attacks may allow a malicious party to compromise communications between components of the distributed systems. For example, two components in a distributed system may relay communications through an intermediary component thereby allowing a malicious party to access the communication, even if encrypted, through the intermediary component. Consequently, a malicious party having access to the intermediary component may allow for communications to either of the components to be spoofed and/or eavesdropped.

Further, use of likeness recognition in voice communication may also be insufficient to protect sensitive information. Deep fakes and other types of likeness spoofing technologies may preclude the use of recognizable likenesses of persons in voice communication from being used as the basis for party authentication in voice communications.

Example embodiments may provide for the improvement of communication security in a distributed system. In contrast to conventional techniques that may rely on connection security and/or likeness recognition (e.g., by users), the disclosed example embodiments may utilize embedding of tokens with steganography, the tokens usable to authenticate another party, to decrypt audio, and/or for other authentication and/or security purposes.

Thus, an example system and device in accordance with embodiments disclosed herein may embed tokens usable for multiple authentication and/or security purposes. Consequently, a distributed system in accordance with one or more embodiments may facilitate secure communications throughout the system.

Although a high level explanation of the operations of example embodiments has been provided above, specific details regarding the configuration of such example embodiments are provided below.

### System Architecture

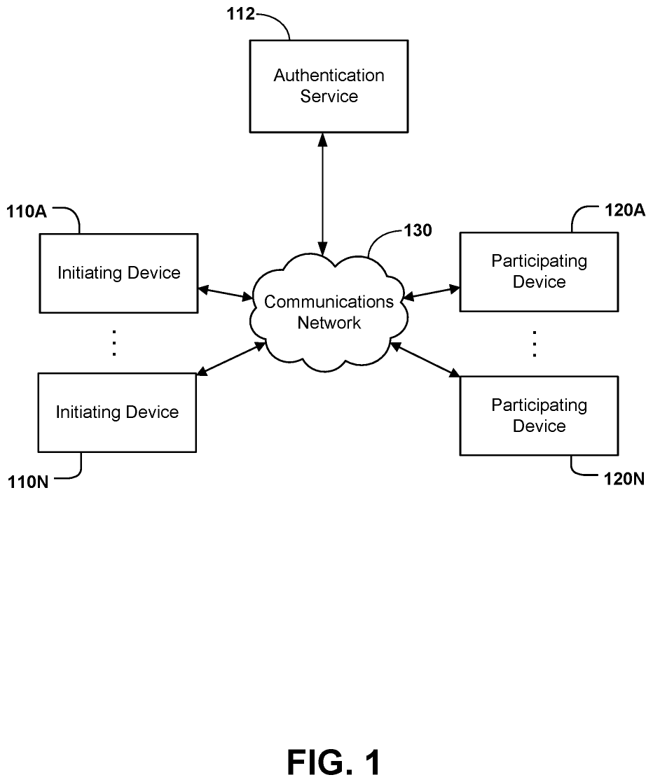

Example embodiments described herein may be implemented using any number and type of computing devices. To this end, FIG. 1 illustrates an example environment within which various embodiments may operate. As illustrated, the environment may include any number of initiating devices 110A-110N and participating devices 120A-120N. These devices may interact with one another to perform any number and types of services. When performing the services, the devices may exchange audio (e.g., voice) so that users of the devices may communicate. However, prior to facilitating distribution of sensitive information via the audio, the device may facilitate authentication of one another using tokens embedded in the audio with steganography. Additionally, prior to transmission of the audio between the devices, the audio may be encrypted and/or otherwise processed to conceal its content. The embedded token may be usable to recover the audio.

As used herein, the term initiating device refers to a device that initiates audio communication with another device (e.g., a participating device). Likewise, the term participating devices refers to a device that is participating in a voice communication initiated by another device. Any device may be an initiating device and/or a participating device (for example, a device may both be in the process of sending audio to another device while also receiving audio from another device) depending on their role, which may change over time.

The initiating devices 110A-110N may be implemented using any number (one, many, etc.) and types of computing devices known in the art, such as desktop or laptop computers, tablet devices, smartphones, or the like. The initiating devices may be associated with corresponding users (e.g., administrators, customers, representatives, other persons, etc.) that use the initiating devices 110A-110N to interact with one or more of the participating devices 120A-120N.

The users and/or applications hosted by the initiating devices may transmit sensitive data (e.g., via audio) to and/or receive sensitive data (e.g., via audio) from the participating devices 120A-120N when interacting with them (and/or other devices). The sensitive data may include, for example, financial information, future plans, personal information, and/or other types of information that may be exploited by unintended recipients of the sensitive data. The unintended recipients may obtain the sensitive data by inadvertent transmission by the initiating devices or through intentional action by the unintended recipients to obtain the sensitive data. To reduce the likelihood of the sensitive data from being obtained by the unintended recipients, the initiating devices and the participating devices may perform one or more authentication, communication security, and/or other actions (collectively the “protective actions”) as part of or with the services provided by the initiating devices 110A-110N and the participating devices 120A-120N.

The participating devices 120A-120N may be implemented using any number and types of computing devices known in the art, such as desktop or laptop computers, tablet devices, smartphones, or the like. The participating devices 120A-120N may provide computer implemented services to and/receive computer implemented services from the initiating devices 110A, 110N and/or other devices.

Like the initiating devices 110A-110N, the participating devices 120A-120N may be associated with corresponding users (e.g., administrators, customers, representatives, other persons, etc.) that use the participating devices 120A-120N to interact with one or more of the initiating devices 110A-110N (and/or other devices). The users and/or applications hosted by the participating devices may transmit and/or receive sensitive data to or from the initiating devices 110A-110N when interacting with them (and/or other devices). To reduce the likelihood of sensitive data being distributed to unintended recipient, the participating devices may perform one or more protective actions such as, for example, token extraction actions (e.g., from an audio package that includes audio), authentication actions (e.g., that the audio was sent by a particular entity), communication security (e.g., decryption), and/or other actions as part of or with the services provided by the participating devices 120A-120N.

The initiating devices 110A-110N and the participating devices 120A-120N may cooperatively provide various computer implemented services to accomplish desirable goals for their respective users. For example, consider a scenario in which an initiating devices is being used by a stock broker to communicate with another stock broken that is using a participating device. The stock broker may desire to talk with the other stock broken. To do so, the stock broken may send and receive audio. To facilitate secure communications between the stock brokers, the initiating device may automatically perform one or more security operations (e.g., concealment operations as part of a concealment scheme) on the audio and/or embed a token in the audio usable to authenticate the audio and/or sender of the audio (e.g., to establish that the audio should be trusted and is not forged). When the audio (e.g., as part of an audio package) is provided to the participating device, the participating device may treat the audio as being suspect (e.g., treated as not being trustworthy, as being spoofed by a malicious party, etc.) unless a token can be extracted from the audio. So long as a successfully extracted token is able to authenticate the stock broker and/or reverse the security operation, the participating device may treat the audio as being trustworthy. Otherwise, the participating device may perform an action set to, for example, alert the other stock broken that the audio may not be from the stock broken (e.g., spoofed), prevent the other stock broken from hearing or using the audio, and/or other actions that may reduce the likelihood of the communications between the devices from being intercepted or otherwise used by unintended receipts to obtain sensitive (or other types) information.

To reduce the likelihood of unintended recipients obtaining information sent between initiating devices and participating devices, embodiments disclosed herein may provide for the performance of protective actions. In contrast to many type of security operations that may rely, to some extent, on trusting various components of a distributed system, a system in accordance with embodiments disclosed herein may not rely on trust of other components of the distributed system.

For example, many distributed systems may presume that other entities in the distributed system will operate in accordance with a protocol or other scheme for securing communications. Unintended recipients may leverage a party's reliance on the expected operation of various components of the distributed system to gain access to sensitive information.

As part of the protective actions, various types of authentications may be performed. The authentications may include mutual authentication and/or authentication through third parties.

The authentication service 112 may be implemented using any number (one, many, etc.) and types of computing devices known in the art, such as desktop or laptop computers, tablet devices, smartphones, or the like.

The authentication service 112 may provide for authentication of initiating devices 110A, 110N and/or participating devices 120A, 120N. To do so, the authentication service 112 may utilize information included in tokens embedded in audio transmitted between the devices. For example, authentication service 112 may include copies of the tokens and/or information associated with the tokens such that a participating device may use the information included in a token received from an initiating device to authenticate the initiating device through the authentication service 112.

To facilitate communications, any of the devices shown in FIG. 1 may be operably connected to each other with communications network 130. Communications network 130 may facilitate communications with one or more wired and/or wireless networks implemented using any suitable communications technology. In one embodiment, communications network 130 includes any number and type of transmission mediums (e.g., electrical cabling, optical cabling, free space channels, etc.) through which signals (e.g., electrical, optical, etc.) on which data is encoded are distributed amongst the devices. The communications network 130 may be implemented using any number and types of communication protocols.

Although FIG. 1 illustrates an environment and implementation in which various functionalities are performed by different devices, in some embodiments some or all of the functionalities of the initiating devices 110A-110N, participating devices 120A-120N, and authentication service 112 into a single device.

### Example Implementing Apparatuses

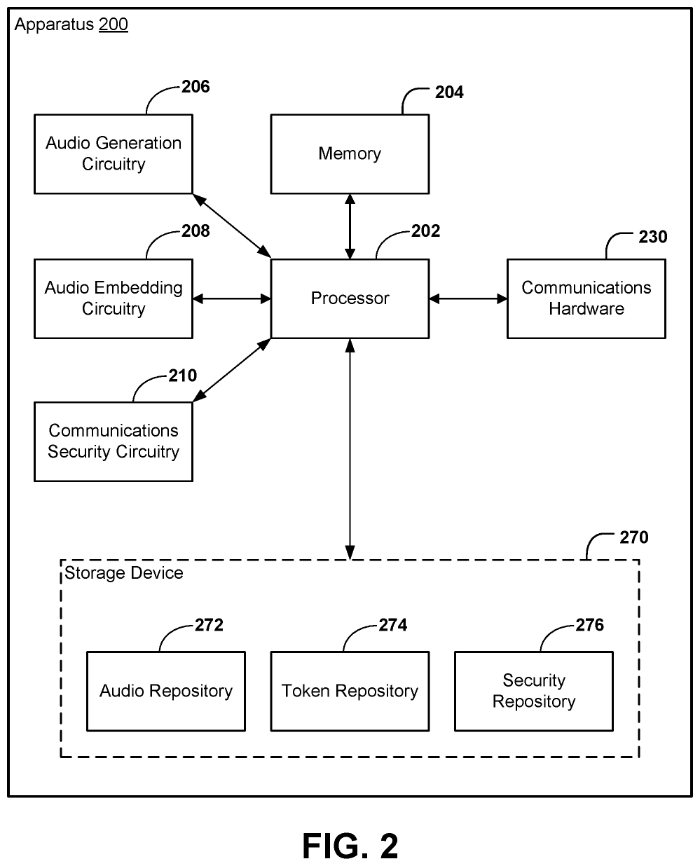

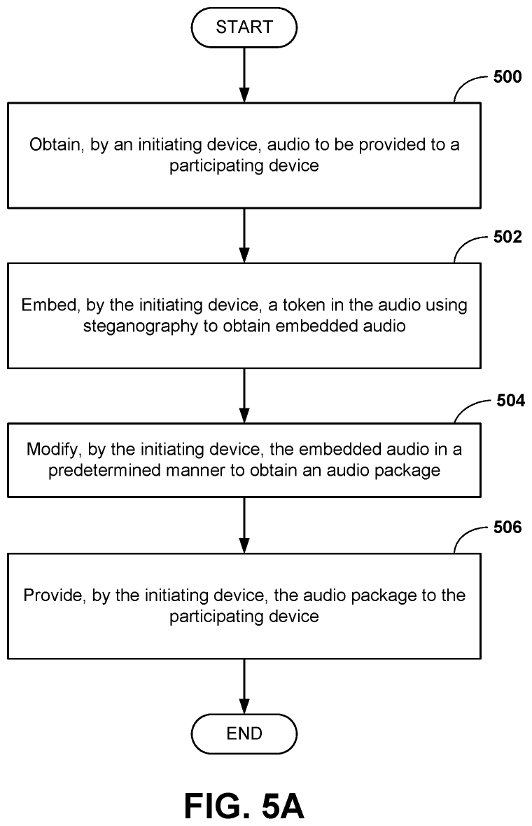

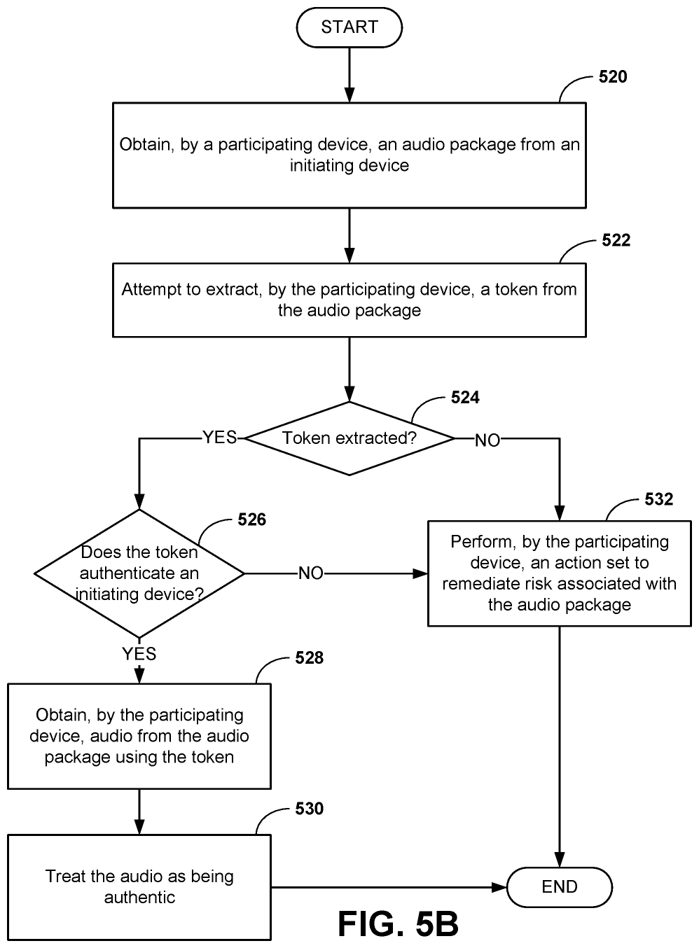

Turning to FIG. 2, any of initiating devices 110A-110N may be embodied by one or more computing devices or servers, shown as apparatus 200 in FIG. 2. As illustrated in FIG. 2, the apparatus 200 may include processor 202, memory 204, audio generation circuitry 206, audio embedding circuitry 208, communications security circuitry 210, communications hardware 230, and storage device 270, each of which will be described in greater detail below. While the various components are only illustrated in FIG. 2 as being connected with processor 202, it will be understood that the apparatus 200 may further comprises a bus (not expressly shown in FIG. 2) for passing information amongst any combination of the various components of the apparatus 200. The apparatus 200 may be configured to execute various operations described above in connection with FIG. 1 and below in connection with FIGS. 5A-5B.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor (e.g., software instructions stored on a separate or integrated storage device 270). In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The audio generation circuitry 206 may be any means such as a device or circuitry embodied in either hardware or a combination of hardware and software that is configured to generate audio and/or a digital representation of an audio. The audio may be generated by, for example, using a microphone or other device to sample sounds in a vicinity proximate to apparatus 200 and/or a user of apparatus 200. The sampling may be used to generate a digital representation of the sampled sounds such as by performing analog to digital conversion on electrical signals obtained from one or more microphones (or other types of sound to electrical signal conversion devices). The digital representation may also be formed by perform any quantity and type of post-processing such as filtering (e.g., to remove noise), compression to facilitate lower computing resource cost distribution of the digital representation, etc. The digital representations (e.g., the audio) of the sounds may be stored in audio repository 272.

The audio embedding circuitry 208 may be any means such as a device or circuitry embodied in either hardware or a combination of hardware and software that is configured to perform one or more modifications on audio obtained by audio generation circuitry 206. The modification may include (i) encryption, and/or (ii) embedding of tokens using steganography. Thus, an audio processed by audio embedding circuitry may have content that is concealed to those that are unaware of the concealment operations performed on the audio.

For example, encrypting the audio may secure content of the audio against listening and/or other use except to those that have access to a decryption key for the audio.

To facilitate use of the audio, a token that allows for authentication of the sender of audio may be embedded in the encrypted audio with steganography. For example, the token (e.g., a sequence of bits), or portions thereof, may be embedded in an audio signal included in the audio that is imperceptible to a person that listens to sound derived from the audio. In another example, the token, or portions thereof, may be embedded in control information, integrity information, and/or other types of information included in the audio, rather than the portion of the audio that specifies an audio signal (e.g., sounds) which may be reproduced using the audio.

Thus, the token, or portions thereof, may be in plain view (e.g., not encrypted) but may not be identified by a party that is unware of the presence of the token. For example, the audio may not include metadata indicating the token and/or the token may repurpose various bits of the audio for communicating content of the token rather than for traditional purposes (e.g., which may be defined by a communication protocol used to communicate the audio between devices). As used herein, the combination of the modified audio and/or token embedded audio may be referred to as an audio package.

The communications security circuitry 210 may be any means such as a device or circuitry embodied in either hardware or a combination of hardware and software that is configured to provide communication security services. The communication security services may include authenticating another device participating in a service and/or establishing encryption keys for securing communications between apparatus 200 and the other device.

When providing it functionality, communication security circuitry 312 may cooperate with audio embedding circuitry 208 to embed all, or a portion, of a token in control information associated with communications between apparatus 200 and a participating device. In this manner, tokens, in part or entirely, may also be transmitted in plain sight as part of a communication layer for an audio package. In some embodiments, communications security circuitry 210 may be entirely responsible for embedding security tokens in audio and may perform the portion of the functionality of audio embedding circuitry 208 directed toward token embedding via steganography.

When embedding tokens, audio embedding circuitry 208 and/or communications security circuitry 210 may utilize tokens in token repository 274. Once embedded, information regarding the embedded tokens may be stored in security repository 276.

The communications hardware 230 may be any means such as a device or circuitry embodied in either hardware or a combination of hardware and software that is configured to receive and/or transmit data from/to a network and/or any other device, circuitry, or module in communication with the apparatus 200. In this regard, the communications hardware 230 may include, for example, a network interface for enabling communications with a wired or wireless communication network. For example, the communications hardware 230 may include one or more network interface cards, data unit processors, antennas, buses, switches, routers, modems, and supporting hardware and/or software, or any other device suitable for enabling communications via a network. Furthermore, the communications hardware 230 may include the processing circuitry for causing transmission of such signals to a network or for handling receipt of signals received from a network.

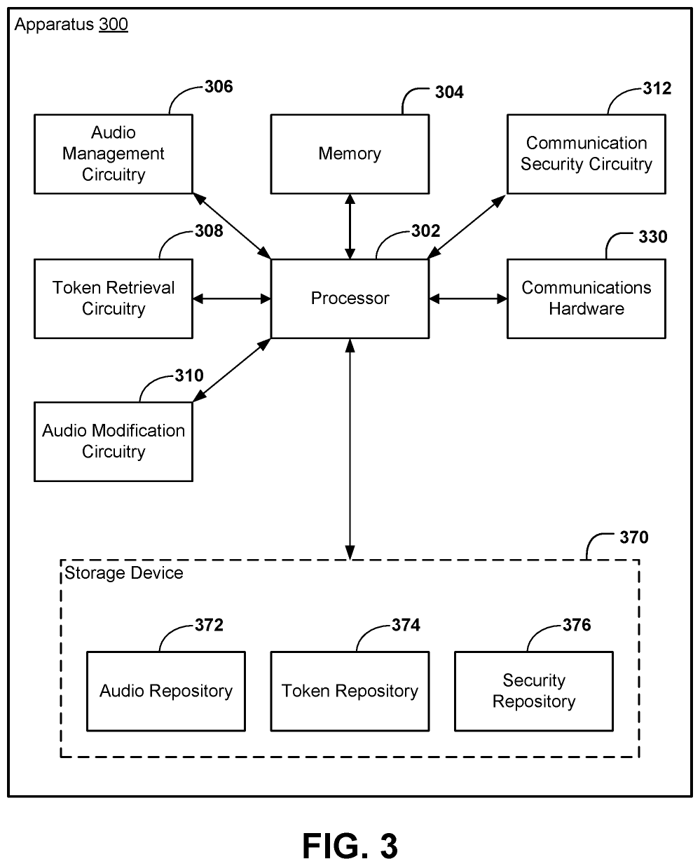

Further, communications hardware 230 may be configured to facilitate error detection and/or correction. For example, when data is provided to communications hardware 230 for transmission to another entity, communications hardware 230 may add additional information to facilitate identification and/or correction of bit flips or other errors in transmission of digital data. Consequently, when data representing audio with an embedded token is transmitted, bit flips or other errors in the transmitted data may be corrected prior to attempting to read the token and/or audio included in the transmitted data. Participating devices may include similar communications hardware (e.g., 330, FIG. 3) to facilitate bidirectional correction of errors in transmission of digital data on which audio with embedded tokens may be encoded.

Finally, the apparatus 200 may include storage device 270 that stores data structures used by audio generation circuitry 206, audio embedding circuitry 208, and/or communications security circuitry 210 to provide their functionalities. Storage device 270 may be a non-transitory storage and include any number and types of physical storage devices (e.g., hard disk drives, tape drives, solid state storage devices, etc.) and/or control circuitry (e.g., disk controllers usable to operate the physical storage devices and/or provide storage functionality such as redundancy, deduplication, etc.).

As noted above, audio repository 272 may store any quantity of information regarding sounds (e.g., produced by a user of apparatus 200), which may be used to generate and audio package. Token repository 274 may include any type and quantity of tokens usable to secure communications of audio and/or authenticate apparatus 200 to other entities. In some embodiments, token repository 274 may be implemented with code usable to dynamically generate tokens when the code is executed with processor 202. Security repository 276 may store any quantity of information regarding tokens and/or other security measures employed to secure communications between apparatus 200 and other devices. Any of these repositories 272, 274, 276 may be implemented using any number and types of data structures (e.g., database, lists, tables, linked lists, etc.).

The tokens of token repository 274 may be generated, distributed, and/or obtained via any method. For example, the tokens may be generated using a random number generator, pseudo random number generator, and/or quantum random number generator (hosted locally and/or remotely). The tokens may be generated via other methods without departing from embodiments disclosed herein.

Any of the tokens may be generated by other devices (e.g., such as a participating device or a third party device tasked with generating and distributing tokens) and may be obtained by apparatus 200. For example, the tokens may be distributed to apparatus 200 and/or other devices using quantum key distribution, transport layer security (or other communications security techniques), and/or one-time-passcode schemes. The tokens may be distributed via other techniques without departing from embodiments disclosed herein.

In some embodiments, apparatus 200 may distribute tokens to other devices such as participating devices. Consequently, both apparatus 200 and participating devices may each have access to the tokens.

While illustrated in FIG. 2 as being a part of apparatus 200, the storage device 270 may be a part of a different device operably connected to apparatus 200.

Although components 202-270 are described in part using functional language, it will be understood that the particular implementations necessarily include the use of particular hardware. It should also be understood that certain of these components 202-270 may include similar or common hardware. For example, the audio generation circuitry 206, audio embedding circuitry 208, and communications security circuitry 210 may each at times leverage use of the processor 202, memory 204, communications hardware 230, and/or storage device 270, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry” with respect to elements of the apparatus therefore shall be interpreted as necessarily including the particular hardware configured to perform the functions associated with the particular element being described. Of course, while the term “circuitry” should be understood broadly to include hardware, in some embodiments, the term “circuitry” may in addition refer to software instructions that configure the hardware components of the apparatus 200 to perform the various functions described herein.

Although audio generation circuitry 206, audio embedding circuitry 208, and communications security circuitry 210 may leverage processor 202 or memory 204 as described above, it will be understood that any of these elements of apparatus 200 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or memory 204, or communications hardware 230 for enabling any functions not performed by special-purpose hardware elements. In all embodiments, however, it will be understood that the processor 202, memory 204, communications hardware 230, and storage device 270 are implemented via particular machinery designed for performing the functions described herein in connection with such elements of apparatus 200.

In some embodiments, various components of the apparatus 200 may be hosted remotely (e.g., by one or more cloud servers) and thus need not physically reside on the corresponding apparatus 200. Thus, some or all of the functionality described herein may be provided by third party circuitry. For example, a given apparatus 200 may access one or more third party circuitries via any sort of networked connection that facilitates transmission of data and electronic information between the apparatus 200 and the third party circuitries. In turn, that apparatus 200 may be in remote communication with one or more of the other components describe above as comprising the apparatus 200.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Returning to the discussion of FIG. 1, any of participating devices 120A-120N may be embodied by one or more computing devices or servers, shown as apparatus 300 in FIG. 3. As illustrated in FIG. 3, the apparatus 300 may include processor 302, memory 304, audio management circuitry 306, token retrieval circuitry 308, audio modification circuitry 310, communication security circuitry 312, communications hardware 330, and storage device 370, each of which may be similar to similarly named components described with respect to FIG. 2. Generally, the components of apparatus 300 may provide similar functions to those similarly named and described with respect to FIG. 2.

The audio management circuitry 306 may be any means such as a device or circuitry embodied in either hardware or a combination of hardware and software that is configured to obtain a digital representation of an audio signal (e.g., which may be usable to reproduce a likeness of a user of an initiating device such that voice communications between users of apparatus 200 and apparatus 300 may be facilitated). The audio may be obtained by, for example, receiving it from an initiating device which may generate it and send it to the participating device as part of an audio package. The audio package may include modified audio that conceals content of an original audio, but that may be reconstructed if the concealment operation(s) used to conceal that content are known. The audio package may also include a token embedded with steganography, as discussed above. Audio (modified and/or constructed) from the audio package (and/or the package itself) may be stored in audio repository 372.

The token retrieval circuitry 308 may be any means such as a device or circuitry embodied in either hardware or a combination of hardware and software that is configured to obtain a token from an audio package. For example, token retrieval circuitry 308 may be aware of the steganography used to embed the token, thereby allowing for the token retrieval circuitry 308 to extract certain bits from the audio package to obtain the token. For example, the token retrieval circuitry 308 may recombine the extracted bits in accordance with the manner in which the bits were embedded with steganography to reconstruct the token. Reconstructed tokens may be stored in token repository 374.

The audio modification circuitry 310 may be any means such as a device or circuitry embodied in either hardware or a combination of hardware and software that is configured to reconstruct audio from modified audio. The audio modification circuitry 310 may reverse the concealment operations to recover the audio, which may be stored as part of audio repository 372.

The communication security circuitry 312 may be any means such as a device or circuitry embodied in either hardware or a combination of hardware and software that is configured to perform one or more protective actions. The protective actions may be performed, for example, when a token is unable to be extracted from an audio package, and/or an extracted token is unable to be used to authenticate an initiating device. For example, when a token is extracted from an audio package, communication security circuitry 312 may use all, or a portion, of the extracted token to authenticate that the audio package is from an entity from which the audio package is believe to be provided. The authentication may be a unilateral authentication, a third party mediated authentication (e.g., through an authentication service), and/or another type of authentication.

For example, all or a portion of the token may be used as a pre-shared secret, as a basis for generation of a key, and/or for other purposes to authenticate an initiating device alleged to have sent, provided, or is associated with the audio package for other reasons. The association may be due, for example, to the audio package including an identifier (or other type of information) indicating that the package is from a particular entity.

If the entity from which the audio package is alleged to originate cannot be authenticated, then the communication security circuitry 312 may cause an action set to be performed. The action set may include any number and types of actions to limit risk associated with the audio package. The actions may include, for example, (i) notifying a user of apparatus 300 that the audio package (and/or an alleged originator) cannot be authenticated, (ii) preventing a user of apparatus 300 from hearing the audio from the audio package, (iii) preventing a user of apparatus 300 from sending audio and/or other types of communications to a device alleged to have originated the audio package, (iv) issuing requests to other entities to attempt to authenticate the alleged originator of the audio package, (v) notifying administrators of the audio package, (vi) logging the audio package, (vii) initiating one or more remedial attempts to authenticate the alleged originator of the audio package, etc. The action set may include additional, different, and/or fewer actions without departing from embodiments disclosed herein.

In the event that an alleged originator is able to be authenticated using a token, various information regarding the authentication may be stored in security repository 376. For example, keys exchanged to establish trust between apparatus 300 and the alleged originator of the audio package may be stored in security repository 376. Likewise, in the event of a failed authentication, information regarding the failed authentication may be stored in security repository 376.

Although components 302-370 are described in part using functional language, it will be understood that the particular implementations necessarily include the use of particular hardware. It should also be understood that certain of these components 302-370 may include similar or common hardware. For example, the audio management circuitry 306, token retrieval circuitry 308, audio modification circuitry 310, and/or communication security circuitry 312 may each at times leverage use of the processor 302, memory 304, communications hardware 330, and/or storage device 370, such that duplicate hardware is not required to facilitate operation of these physical elements of the apparatus 300 (although dedicated hardware elements may be used for any of these components in some embodiments, such as those in which enhanced parallelism may be desired). Use of the terms “circuitry” with respect to elements of the apparatus therefore shall be interpreted as necessarily including the particular hardware configured to perform the functions associated with the particular element being described. Of course, while the term “circuitry” should be understood broadly to include hardware, in some embodiments, the term “circuitry” may in addition refer to software instructions that configure the hardware components of the apparatus 300 to perform the various functions described herein.

Although audio management circuitry 306, token retrieval circuitry 308, audio modification circuitry 310, and/or communication security circuitry 312 may leverage processor 302 or memory 304 as described above, it will be understood that any of these elements of apparatus 300 may include one or more dedicated processor, specially configured field programmable gate array (FPGA), or application specific interface circuit (ASIC) to perform its corresponding functions, and may accordingly leverage processor 302 executing software stored in a memory (e.g., memory 304), or memory 304, or communications hardware 330 for enabling any functions not performed by special-purpose hardware elements. In all embodiments, however, it will be understood that the processor 302, memory 304, communications hardware 330, and storage device 370 are implemented via particular machinery designed for performing the functions described herein in connection with such elements of apparatus 300.

In some embodiments, various components of the apparatus 300 may be hosted remotely (e.g., by one or more cloud servers) and thus need not physically reside on the corresponding apparatus 300. Thus, some or all of the functionality described herein may be provided by third party circuitry. For example, a given apparatus 300 may access one or more third party circuitries via any sort of networked connection that facilitates transmission of data and electronic information between the apparatus 300 and the third party circuitries. In turn, that apparatus 300 may be in remote communication with one or more of the other components describe above as comprising the apparatus 300.

As will be appreciated based on this disclosure, example embodiments contemplated herein may be implemented by an apparatus 300. Furthermore, some example embodiments may take the form of a computer program product comprising software instructions stored on at least one non-transitory computer-readable storage medium (e.g., memory 304). Any suitable non-transitory computer-readable storage medium may be utilized in such embodiments, some examples of which are non-transitory hard disks, CD-ROMs, flash memory, optical storage devices, and magnetic storage devices. It should be appreciated, with respect to certain devices embodied by apparatus 300 as described in FIG. 3, that loading the software instructions onto a computing device or apparatus produces a special-purpose machine comprising the means for implementing various functions described herein.

As will be appreciated based on this disclosure, example embodiments contemplated herein may be implemented by apparatus 300. Furthermore, some example embodiments may take the form of a computer program product comprising software instructions stored on at least one non-transitory computer-readable storage medium (e.g., memory 304). Any suitable non-transitory computer-readable storage medium may be utilized in such embodiments, some examples of which are non-transitory hard disks, CD-ROMs, flash memory, optical storage devices, and magnetic storage devices. It should be appreciated, with respect to certain devices embodied by apparatus 300 as described in FIGS. 5A-5B, that loading the software instructions onto a computing device or apparatus produces a special-purpose machine comprising the means for implementing various functions described herein.

Having described specific components of example apparatuses 200 and 300, example embodiments are described below.

### Example Implementing Data Structures

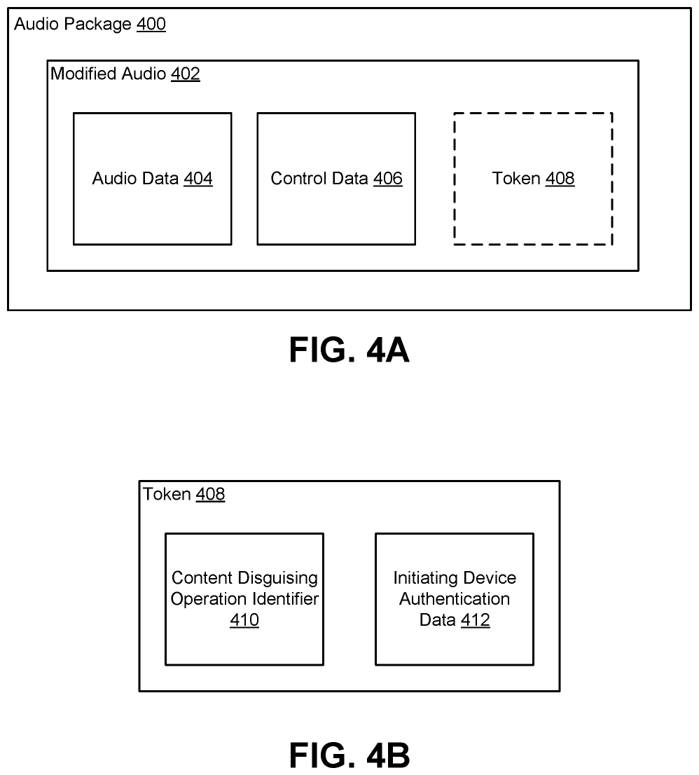

Turning to FIG. 4A, an audio package 400 in accordance with one or more embodiments is shown. The audio package 400 may by generated by an initiating device and provided to a participating device. The audio package may include a modified audio 402 such that content of the audio on which modified audio 402 is based cannot be reconstructed (e.g., in a computationally reasonable manner) if the manner which the audio was modified is not known. Thus, the audio package 400, even if obtained by an unintended recipient, may not be used by an unintended recipient to obtain sensitive information from the audio. Consequently, the audio package 400 may be able to be transmitted in a distributed system securely even if the encryption or other means to secure communications between devices of the distributed system is compromised.

The modified audio 402 may include audio data 404, control data 406, and a token 408. In FIG. 4A, token 408 is drawn with a dashed outline to indicate that it may be a separate, discernable element. Rather, as noted above and discussed below, token 408 may be integrated with audio data 404 and/or control data 406. The audio data 404 may include modified audio data, as discussed above. The control data 406 may include information such as parity information, check sums, and/or other information usable to verify integrity of the audio package 400.

The token 408, may correspond to a bit sequence, as discussed above. In an embodiment, the token 408 is a security token usable for authentication. The token 408 may include any type and quantity of information usable for these and/or other purposes.

Token 408 may be embedded with audio data 404 and/or control data 406 via steganography such that the contents of token 408 are not encrypted. Rather, the content of token 408 may be in plain view but positioned in audio data 404 and control data 406 such that the presence of token 408 is not indicated by audio package 400. For example, audio package 400 may not include metadata specify the location of token 408. However, both an initiating device and a participating device may be aware of the manner of embedding of token 408 with steganography. Consequently, both types of devices may be able to extract a token (if it is present) from audio package 400 while other types of devices may not be able to for lack of knowledge regarding how the steganography is performed by the initiating device. In contrast, devices that are unaware of the manner of embedding of token 408 may view the presence of token 408 as noise or other types of transmission errors in audio package 400. Thus, the unaware devices may not take action with respect to or even be aware of the presence of token 408 even though it may have an impact on the interpretation of audio package 400 by the unaware devices.

Turning to FIG. 4B, a diagram of the token 408 in accordance with an embodiment is shown. As seen in FIG. 4B, token 408 may include a content concealment operation identifier 410 and initiating device authentication data 412. The content concealment operation identifier 410 may indicate how the modified audio 402 was modified with respect to a base audio (e.g., such as a voice of a user of an initiating device). The initiating device authentication data 412 may include any type and quantity of data usable to authenticate an initiating device to a participating device. The initiating device authentication data 412 may include, for example, (i) a data structure derived from a pre-shared secret known to the initiating device and participating device, (ii) a data structure usable with an authentication service to authenticate the initiating device, (iii) a data structure derived from a public-private key such that the participating device is able to authenticate that the included data structure is from the entity from which audio package 400 is alleged to originate, and/or (iv) other information usable to authenticate an initiating device.

### Example Apparatus Operations for Communication Security

Turning to FIGS. 5A-5B, example flowcharts are illustrated that contain example operations implemented by various embodiments described herein. FIGS. 5A-5B illustrate example operations for securing communications between devices.

The operations illustrated in FIG. 5A may, for example, be performed by initiating devices shown in FIG. 1, which may in turn be embodied by an apparatus 200, which is shown and described in connection with FIG. 2. To perform the operations described below, the apparatus 200 may utilize one or more of processor 202, memory 204, audio generation circuitry 206, audio embedding circuitry 208, communications security circuitry 210, communications hardware 230, storage device 270, and/or any combination thereof.

The operations illustrated in FIG. 5B may, for example, be performed by participating devices shown in FIG. 1, which may in turn be embodied by an apparatus 300, which is shown and described in connection with FIG. 3. To perform the operations described below, the apparatus 300 may utilize one or more of processor 302, memory 304, audio management circuitry 306, token retrieval circuitry 308, audio modification circuitry 310, communication security circuitry 312, communications hardware 330, storage device 370, and/or any combination thereof.

Turning first to FIG. 5A, example operations are shown for initiating communications by an initiating device with a participating device. For example, an initiating device may be performing services that may cause it to need to distribute sensitive data to a participating device, such as when a use of an initiating device may wish to talk with a user of a participating device. To reduce the likelihood of the sensitive data being distributed to or intercepted by an unintended recipient, the initiating device may generate an audio package which conceals the content of the audio while allowing a participating device to both authenticate the initiating device and reveal the concealed audio.

As shown by operation 500, the apparatus 200 includes means, such as processor 202, memory 204, and audio generation circuitry 206, or the like, for obtaining audio that is to be provided to the participating device. The audio may be obtained by, for example, using a transducer such as a microphone to convert voice or other sound from a user of apparatus 200 into an electrical signal. The electrical signal may be read to generate digital data corresponding to the electrical signal.

As shown by operation 502 the apparatus 200 includes means, such as processor 202, memory 204, audio embedding circuitry 208, and communications security circuitry 210, or the like, for embedding a token in the audio using steganography to obtain embedded audio. The token may be embedded, for example, as an imperceptible portion of the audio signal. The token may be embedded, for example, as part of (e.g., a substitution for) control information for the modified audio signal. For example, the token may be broken down into bits, bytes, etc. and added to various locations in the audio signal or the control information (e.g., metadata) for the audio signal. The control information may provide for integrity or other types of checks of the audio signal. The portions of the token may be substituted in for this information. Consequently, while the bits corresponding to the token may be in plain sight in the audio package, the audio package may not indicate the presence of the bits and, in fact, may indicate that the bits perform other functions (e.g., control, integrity, verification, etc.) rather than the function of a token for authentication and/or audio reconstruction.

As shown by operation 504 the apparatus 200 includes means, such as processor 202, memory 204, audio embedding circuitry 208, and communications security circuitry 210, or the like, for modifying the embedded audio in a predetermined manner to obtain an audio package. The embedded audio may be modified by performing one or more concealment operations (e.g., in accordance with a content concealment scheme). The concealment operations may include encrypting the embedded audio. Encrypting the embedded audio may convert it into code that may be read using an encryption key used to encrypt the embedded audio. These operations may place the resulting modified embedded audio in a form that may not be interpretable by another party that is unaware of the concealment operations performed on the embedded audio to obtain the embedded audio.

As shown by operation 506 the apparatus 200 includes means, such as processor 202, memory 204, communications security circuitry 210, and communications hardware 230, or the like, for providing the audio package to the participating device. Audio package may be provided to the participating device by sending it (or portions thereof), via one or more messages or other type of communication protocol compliant data structure, via a communication system to the participating device.

The method may end following operation 506.

Turning to FIG. 5B, example operations are shown for participating in communications by a participating device (e.g., 300) with an initiating device. For example, a participating device may receive a request for voice communications with a user of an initiating device by receiving an audio package from the initiating device. However, when received, the participating device may not be able to immediately trust that the audio package is from the device (e.g., the initiating device) from which the audio package is alleged to originate.

As shown by operation 520, the apparatus 300 includes means, such as processor 302, memory 304, audio management circuitry 306, communications hardware 330, or the like, for obtaining an audio package from an initiating device. The audio package may be obtained from the initiating device by receiving it in one or more messages (or other type of communication protocol complaint data structure) obtained from a communication system to which the apparatus 300 is operably connected.

As shown by operation 522, the apparatus 300 includes means, such as processor 302, memory 304, and token retrieval circuitry 308, or the like, for attempting to extract a token from the audio package. To attempt to extract the token, the apparatus 300 may be aware of steganography employed by the initiating device (e.g., where and how bits of the token are stored in plain sight in the audio package), extract bits from the audio package corresponding to the token, and reconstruct the token using the bits.

As shown by operation 524, the apparatus 300 includes means, such as processor 302, memory 304, audio modification circuitry 310, communication security circuitry 312, and communications hardware 330, or the like, for determining whether a token was extracted. If an audio package is spoofed or otherwise is not authentic, the audio package may not actually include a token or may include a bit sequence place of the token that does not operate as a token. The token may include bit sequences representing identifiers or other information usable to authenticate whether a token was extracted from the audio package. For example, the bit sequence may include a bit sequence corresponding to a signature thereby allowing initiating device to use a public key associated with the initiating device alleged to have originated the audio package to determine whether a token has actually been extracted. The determination may be made via other methods without departing from embodiments disclosed herein.

If it is determined that a token has been extracted, then the method may proceed to operation 526. Otherwise the method may proceed to operation 532.

As shown by operation 526, the apparatus 300 includes means, such as processor 302, memory 304, audio modification circuitry 310, communication security circuitry 312, and communications hardware 330, or the like, for determining whether the token authenticates the initiating device alleged to have originated the audio package. The determination may be made by using the token to perform an authentication of the audio package with the initiating device. The authentication may use all, or a portion, of the token and may be a unilateral, mutual, and/or third party mediated authentication.

If it is determined that the token indicates that the initiating device is authenticated, then the method may proceed to operation 528. Otherwise the method may proceed to operation 532.

As shown by operation 528, the apparatus 300 includes means, such as processor 302, memory 304, and audio modification circuitry 310, or the like, for obtaining audio from the audio package using the token. The audio may be reconstructed by decrypting the audio

As shown by operation 530, the apparatus 300 includes means, such as processor 302, memory 304, audio modification circuitry 310, and communication security circuitry 312, or the like, for treating the audio as being authentic. The audio may be treated as authentic by presenting it to a user of the participating device without indicating that it may be inauthentic and/or by indicating that an authentication with respect to the audio (and/or source of the audio) has been completed.

The method end following operation 530.

Returning to operations 524 and 526, the method may proceed to operation 532 following these steps in some scenarios.

As shown by operation 532, the apparatus 300 includes means, such as processor 302, memory 304, audio modification circuitry 310, and communication security circuitry 312, or the like, for performing an action set to remediate risk associated with the audio package. The action set may include any number and type of actions for remediating the risk associated with the audio package. The action set may include, for example, (i) indicating, to a user of the participating device, that the audio is not from an authenticated source (e.g., may be inauthentic), (ii) prevent a user of the participating device from consuming the audio and/or sending information to an alleged originator of the audio package, (iii) initiating a remedial authentication of the alleged originator of the audio package, and/or other actions that may otherwise reduce the likelihood of sensitive data from being obtained by unintended recipients.

The method may end following operation 532.

FIGS. 5A-5B illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be embodied by software instructions. In this regard, the software instructions which embody the procedures described above may be stored by a memory of an apparatus employing an embodiment of the present invention and executed by a processor of that apparatus. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a computer-readable memory that may direct a computing device or other programmable apparatus to function in a particular manner, such that the software instructions stored in the computer-readable memory produce an article of manufacture, the execution of which implements the functions specified in the flowchart blocks. The software instructions may also be loaded onto a computing device or other programmable apparatus to cause a series of operations to be performed on the computing device or other programmable apparatus to produce a computer-implemented process such that the software instructions executed on the computing device or other programmable apparatus provide operations for implementing the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

In some embodiments, some of the operations above may be modified or further amplified. Furthermore, in some embodiments, additional optional operations may be included. Modifications, amplifications, or additions to the operations above may be performed in any order and in any combination.

### Example System Operations

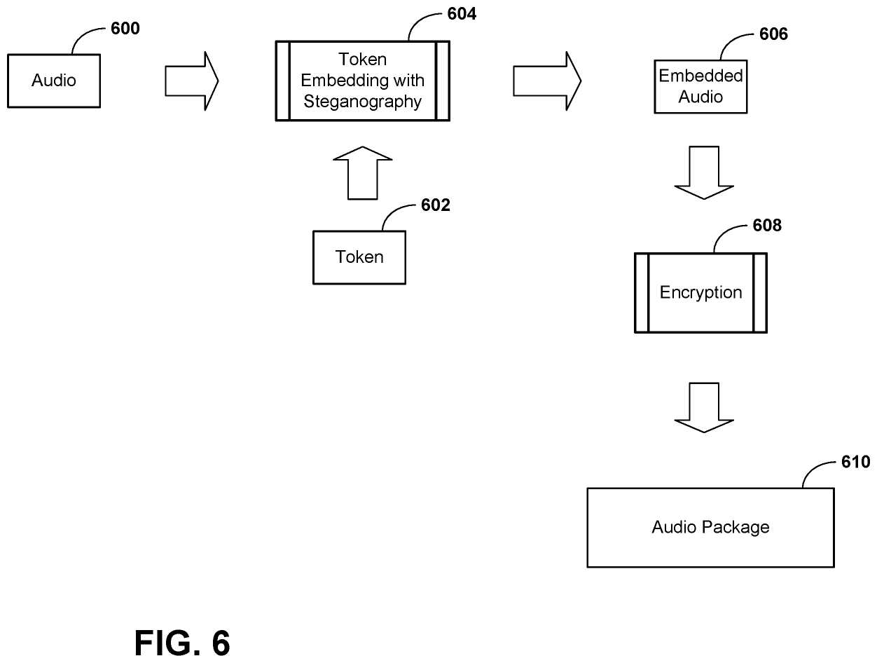

As noted above, initiating devices and participating devices may generate and utilize data structures to secure communications between these devices. FIG. 6 shows a diagram illustrating example operations performed by components of a distributed system to generate a data structure for securing communications. In the figure, the process blocks (e.g., 604, 608) indicate operations performed on data structured indicated by blocks (e.g., 600, 606).

Turning to FIG. 6, audio 600 may be obtained by audio generation circuitry 206. The audio 600 may be obtained by recording the voice of a user of apparatus 200 in a digital format.

Audio 600 may be subjected to token embedding with steganography 604 of token 602 by audio embedding circuitry 208 or communications security circuitry 210 to obtain embedded audio 606. The token 602 may include information to authenticate apparatus 200 and/or facilitate other security operations.

Once obtained, embedded audio 606 may be subject to concealment operations performed by audio embedding circuitry 208 to obtain audio package 612. For example, embedded audio 606 may be subjected to encryption 608 and/or other types of security operations (e.g., such as signing or other operations not shown here). The result of these operations may be audio package 610.

Audio package 610 may require use of an encryption key with which audio 600 is encoded to gain access to audio 600 and/or token 602 embedded in the audio. For example, encryption 608 may include any number of substitutions, transposition, and/or other bit operations (e.g., shifts, inverse, exclusive or operations, etc.) which may need to be reversed to gain access to the embedded audio. Thus, the resulting audio package 610 may provide a first layer of security while also allowing for other layers of security through authentication (or other operations) using the embedded token.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method for authenticating audio communications between an initiating device and a participating device, the method comprising:
obtaining, by audio generation circuitry of the initiating device, audio to be provided to the participating device;
modifying, by audio embedding circuitry of the initiating device, the audio based on a content concealment scheme to obtain an audio package that conceals content of the audio;
embedding, by communications security circuitry of the initiating device and using steganography, a token in the audio package, such that the token is not modified; and
after embedding the token in the audio package, providing, by communication hardware of the initiating device, the audio package to the participating device.

2. The method of claim 1, wherein modifying the audio comprises:
performing, using a selected content concealment scheme, a content concealment operation on the audio so that the content of the audio is unable to be reconstructed using the audio package without access to the content concealment scheme.

3. The method of claim 2, wherein the token identifies the content concealment scheme.

4. The method of claim 3, wherein the content concealment operation comprises:
encrypting the content to obtain encrypted content.

5. The method of claim 4, wherein the content concealment operation comprises:
scrambling the content or the encrypted content to obtain scrambled content.

6. The method of claim 5, wherein the token comprises a bit sequence usable to:
perform an authentication for the audio package.

7. The method of claim 6, wherein the bit sequence is usable to authenticate the initiating device to the participating device.

8. (canceled)

9. The method of claim 1, wherein the token is embedded in control information for the audio package.

10. The method of claim 9, wherein the audio comprises a voice communication directed to a user of the participating device, the initiating device and the participating device being part of a distributed system in which communications are not intrinsically trusted.

11. The method of claim 10, wherein the initiating device and the participating device are operably connected to each other via a network environment and are subject to compromise by other entities in the network environment.

12. An initiating device for secure audio communications with a participating device, the initiating device comprising:
audio generation circuitry configured to obtain audio to be provided to the participating device;
audio embedding circuitry configured to modify the audio based on a content concealment scheme to obtain an audio package that conceals content of the audio;
communications security circuitry configured to embed, using steganography, a token in the audio package such that the token is not modified; and
communication hardware configured to provide, after embedding the token in the audio package, the audio package to the participating device.

13. The initiating device of claim 12, wherein modifying the audio comprises:
performing, using a selected content concealment scheme, a content concealment operation on the audio so that the content of the audio is unable to be reconstructed using the audio package without access to the content concealment scheme.

14. The initiating device of claim 13, wherein the token identifies the content concealment scheme.

15. The initiating device of claim 14, wherein the content concealment operation comprises:
encrypting the content to obtain encrypted content.

16. The initiating device of claim 15, wherein the content concealment operation comprises:
scrambling the content or the encrypted content to obtain scrambled content.

17. The initiating device of claim 16, wherein the token comprises a bit sequence usable to:
perform an authentication for the audio package.

18. The initiating device of claim 17, wherein the bit sequence is usable to authenticate the initiating device to the participating device.

19. (canceled)

20. The initiating device of claim 12, wherein the token is embedded in as control information for the audio package.

21-36. (canceled)
